(19) United States
(12) Patent Application Publication
(10) Pub. No.: US 2026/0291267 A1
(43) Pub. Date: Sep. 24, 2026

(54) TWO-CONNECTOR DEVICE DETECTION AND CHARGING

(71) Applicant: QUALCOMM Incorporated, San Diego, CA (US)

(72) Inventors: Christian CAMPORESE, Cambridge (GB); Manjunatha POOJARY, Cambridge (GB); Richard NGUYEN, Burghaslach (DE)

(21) Appl. No.: 19/088,390

(22) Filed: Mar. 24, 2025

(51) Int. Cl. H02J 7/60; H04R 1/02; H04R 1/1025

(52) U.S. Cl. CPC H02J 7/685; H04R 1/02; H04R 1/1025

(57) ABSTRACT

Techniques and apparatus for detecting and charging a portable device with a charging device using only two connectors between the devices. One example portable device generally includes a charging connector for coupling to the battery; a reference potential connector; a resistive element and a transistor coupled in series between the charging connector and the reference potential connector; and a comparator including an input coupled to the charging connector and an output coupled to a gate of the transistor.

### TECHNICAL FIELD

Certain aspects of the present disclosure generally relate to electronic devices and, more particularly, to electronic device detection and charging using only two electrical connectors.

### BACKGROUND

The prevalence of portable electronic devices in everyday life continues to grow as many people increasingly rely on portable electronic devices for many activities. Portable electronic devices may include, for example, speakers or wearable devices, such as headphones, earbuds, or extended reality (XR) devices (e.g., augmented reality (AR), virtual reality (VR), or mixed reality (MR) devices). Portable electronic devices are frequently powered by one or more batteries. When a battery (or batteries) of a portable electronic device become at least partially discharged (e.g., the battery is dead or drained), the battery may be recharged by coupling (e.g., connecting) the portable electronic device to a charging device. For example, an earbud or other portable electronic device may be inserted into a portable charging case to enable the recharging of the battery of the earbud or other portable electronic device.

### SUMMARY

The systems, methods, and devices of the disclosure each have several aspects, no single one of which is solely responsible for its desirable attributes. Without limiting the scope of this disclosure as expressed by the claims that follow, some features are discussed briefly below. After considering this discussion, and particularly after reading the section entitled “Detailed Description,” one will understand how the features of this disclosure provide the advantages described herein.

Certain aspects of the present disclosure provide a portable device configured to receive power from a battery. The portable device generally includes a charging connector for coupling to the battery; a reference potential connector; a resistive element and a transistor coupled in series between the charging connector and the reference potential connector; and a comparator including an input coupled to the charging connector and an output coupled to a gate of the transistor.

Certain aspects of the present disclosure are directed to a method of charging a portable device with a battery. The method generally includes (i) turning on, using a comparator, a transistor when a voltage at a charging connector for coupling to the battery is higher than a first voltage threshold, but lower than a second voltage threshold, the transistor being coupled in series with a resistive element between the charging connector and a reference potential connector, wherein the comparator includes an input coupled to the charging connector and includes an output coupled to a gate of the transistor; and (ii) turning off, using the comparator, the transistor when the voltage at the charging connector is higher than the second voltage threshold.

Certain aspects of the present disclosure provide a charging device configured to supply power to a portable device. The charging device generally includes a charging connector for coupling to the portable device; a voltage regulator; and selection circuitry coupled between the voltage regulator and the charging connector, the selection circuitry being configured to selectively apply a voltage to the charging connector. In certain aspects, the selection circuity may include a first switch coupled between an output of the voltage regulator and the charging connector; a voltage node; and a second switch coupled between the charging connector and the voltage node.

Certain aspects of the present disclosure are directed to a method of using a charging device to supply power. The method generally includes operating the charging device in a first state, wherein operating in the first state comprises: (i) disabling a voltage regulator; (ii) opening a first switch coupled between an output of the voltage regulator and a charging connector for coupling to a portable device; and (iii) closing a second switch coupled between a voltage node and the charging connector.

Certain aspects of the present disclosure are directed to a method of using a charging device to supply power. The method generally includes operating the charging device in a first state, wherein operating in the first state comprises: (i) disabling a first voltage output of a voltage regulator; (ii) opening a first switch coupled between the high voltage output of the voltage regulator and a charging connector for coupling to a portable device; and (iii) closing a second switch coupled between a low voltage output of the voltage regulator and the charging connector.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 is a block diagram of a device charging system that includes an example charger and an example portable device, in accordance with certain aspects of the present disclosure.

FIG. 2A is a block diagram of a three-connector device detection and charging system that includes an example charging device circuit and an example portable device circuit, in accordance with certain aspects of the present disclosure.

FIG. 2B is a block diagram of a two-connector device detection and charging system that includes an example charging device circuit and an example portable device circuit, in accordance with certain aspects of the present disclosure.

FIG. 3 is a timing diagram illustrating various voltage or current signals of the example charging device circuit and the example portable device circuit of FIG. 2B during different states, in accordance with certain aspects of the present disclosure.

FIGS. 4A, 4B, and 4C are block diagrams of the two-connector device detection system of FIG. 2B during the different states of FIG. 3, in accordance with certain aspects of the present disclosure.

FIG. 5 is a flow diagram of example operations for charging a portable device with a battery, in accordance with certain aspects of the present disclosure.

FIG. 6 is a flow diagram of example operations for using a charging device to supply power, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Certain aspects of the present disclosure provide techniques and apparatus for detecting and charging a portable device with a charging device using only two electrical connectors between the devices. An example portable device may include a charging connector and a reference potential connector, which correspond to a charging connector and a reference potential connector of the charging device. The portable device may also include (i) a pulldown resistive element and a pulldown transistor, coupled in series between the charging connector and the reference potential connector, and (ii) a comparator with an input coupled to the charging connector and an output coupled to a gate of the pulldown transistor. The comparator may be configured to control the pulldown transistor based on the voltage at the charging connector of the portable device. An example charging device may include a charging connector for coupling to the portable device, a voltage regulator, and selection circuitry coupled between the voltage regulator and the charging connector, the selection circuitry being configured to selectively apply a voltage to the charging connector. In certain aspects, the selection circuity may include a first switch coupled between an output of the voltage regulator and the charging connector, a voltage node, and a second switch coupled between the charging connector and the voltage node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

The word “exemplary” is used herein to mean “serving as an example, instance, or illustration.” Any aspect described herein as “exemplary” is not necessarily to be construed as preferred or advantageous over other aspects.

As used herein, the term “connected with” in the various tenses of the verb “connect” may mean that element A is directly connected to element B or that other elements may be connected between elements A and B (i.e., that element A is indirectly connected with element B). In the case of electrical components, the term “connected with” may also be used herein to mean that a wire, trace, or other electrically conductive material is used to electrically connect elements A and B (and any components electrically connected therebetween).

### Example Device Charging System

The prevalence of portable devices in everyday life continues to increase. Portable devices may include, for example, a portable speaker (e.g., a portable Bluetooth speaker) or a wearable device, such as a headphone, an earbud, or an extended reality (XR) device (e.g., augmented reality (AR), virtual reality (VR), or mixed reality (MR) device). Portable devices are frequently powered by one or more batteries. When the battery (or batteries) of the portable device become at least partially discharged (e.g., the battery is dead or drained), the battery may be recharged by coupling (e.g., connecting) the portable device to a charging device. For example, an earbud or other portable device may be inserted into a (portable) charging case to enable the recharging of the battery of the earbud or other portable device. In some cases, the charging device may utilize a voltage regulator to provide power for charging the battery of the portable device.

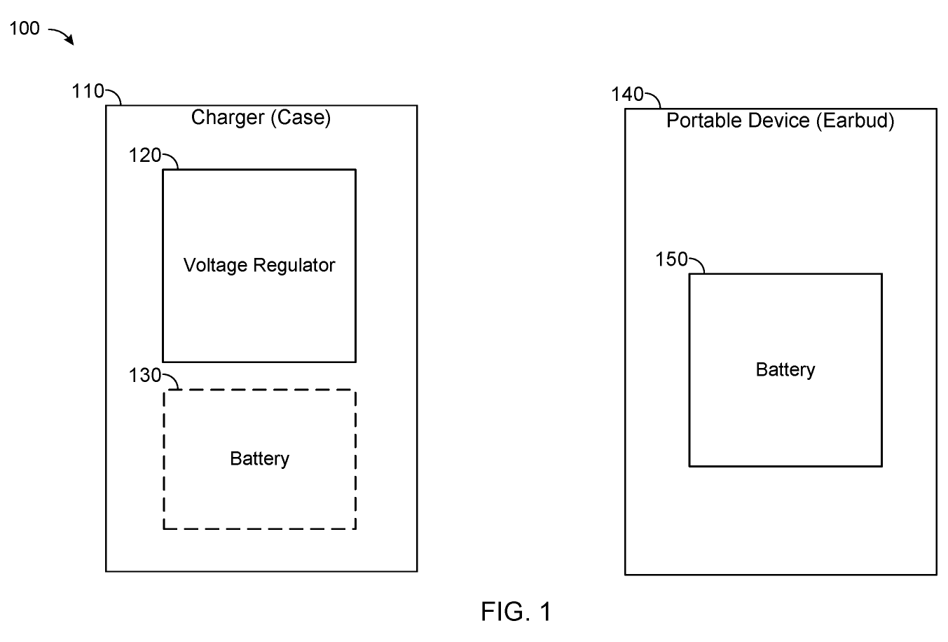

FIG. 1 is a block diagram of a charging system 100 that includes an example charger 110 and an example portable device 140, in accordance with certain aspects of the present disclosure. The charger 110 (which may also be referred to as a “charging device”) may include a voltage regulator 120 and may optionally include a battery (or batteries) 130. The voltage regulator may be implemented by, for example, a switched-mode power supply (SMPS), such as a buck, boost, or buck-boost converter. The voltage regulator 120 may be coupled to and receive input power from at least one of a wall adapter, a wireless power charger, and/or the battery 130 and may output power for charging another device, such as the portable device 140.

In certain aspects, the battery 130 may comprise a single cell or multiple cells connected in series and/or in parallel. The battery 130 may be a rechargeable battery, such as a nickel-metal hydride or lithium-ion battery. In some cases, the charger 110 may include the battery 130 and one or more additional independent batteries (not shown). Each of the additional independent batteries may comprise a single cell or multiple cells connected in series and/or in parallel.

The portable device 140 may be a battery-operated device such as a portable speaker (e.g., a portable Bluetooth speaker) or a wearable device, such as a headphone (e.g., an over-ear headphone, on-ear headphone, or an in-ear headphone, such as an earbud), earphone, earpiece, ring, band (e.g., headband, neckband, armband, banded headset, etc.), hearing aid, extended reality (XR) device (e.g., augmented reality (AR), virtual reality (VR), or mixed reality (MR) device), or the like. As such, the portable device 140 may include a battery 150, which may be used to power the various components of the portable device 140 (e.g., when another power source—such as a wall adapter or a wireless power charger—is unavailable).

In certain aspects, the battery 150 may comprise a single cell or multiple cells connected in series and/or in parallel. The battery 150 may be a rechargeable battery, such as a nickel-metal hydride or lithium-ion battery. In some cases, the portable device 140 may further include additional independent batteries (not shown). Each of the additional independent batteries may comprise a single cell or multiple cells connected in series and/or in parallel.

When the battery (or batteries) 150 of the portable device 140 become at least partially discharged (e.g., the battery 150 is dead or drained), the battery 150 may be recharged by coupling (e.g., connecting) the portable device 140 to the charger 110. The charger 110 may utilize the voltage regulator 120 to provide power for charging the battery 150 of the portable device 140. To save power, the voltage regulator 120 may be enabled when the portable device 140 is coupled to the charger 110 and disabled when the portable device 140 is decoupled (e.g., disconnected) from the charger 110. As a result, it may be beneficial for the charger 110 to be able to detect the presence of the portable device 140.

### Example Three-Connector Device Detection and Charging System

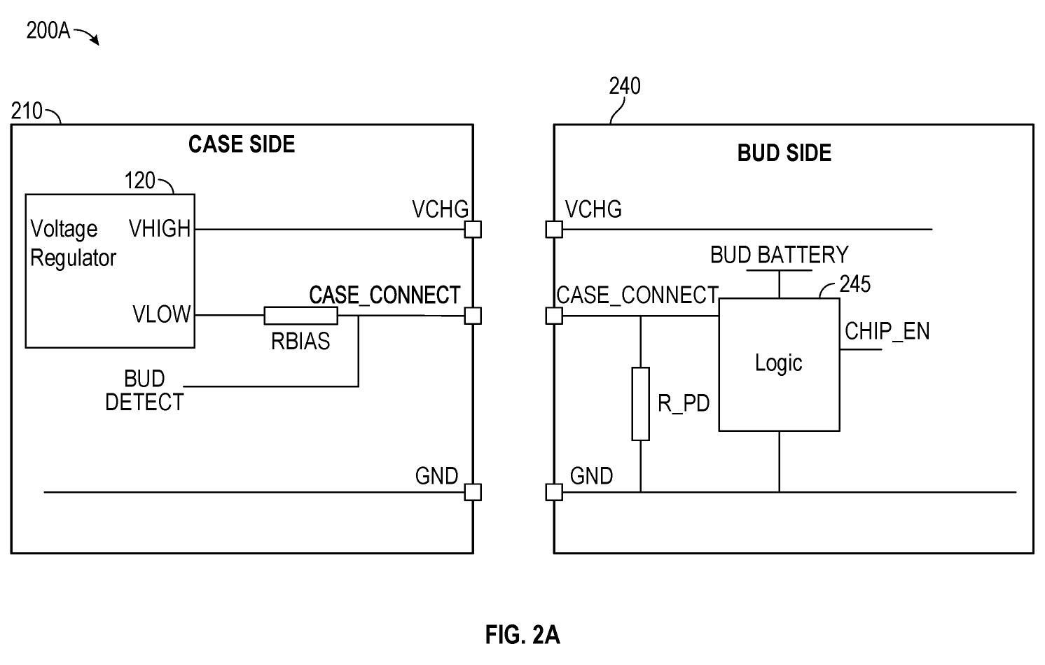

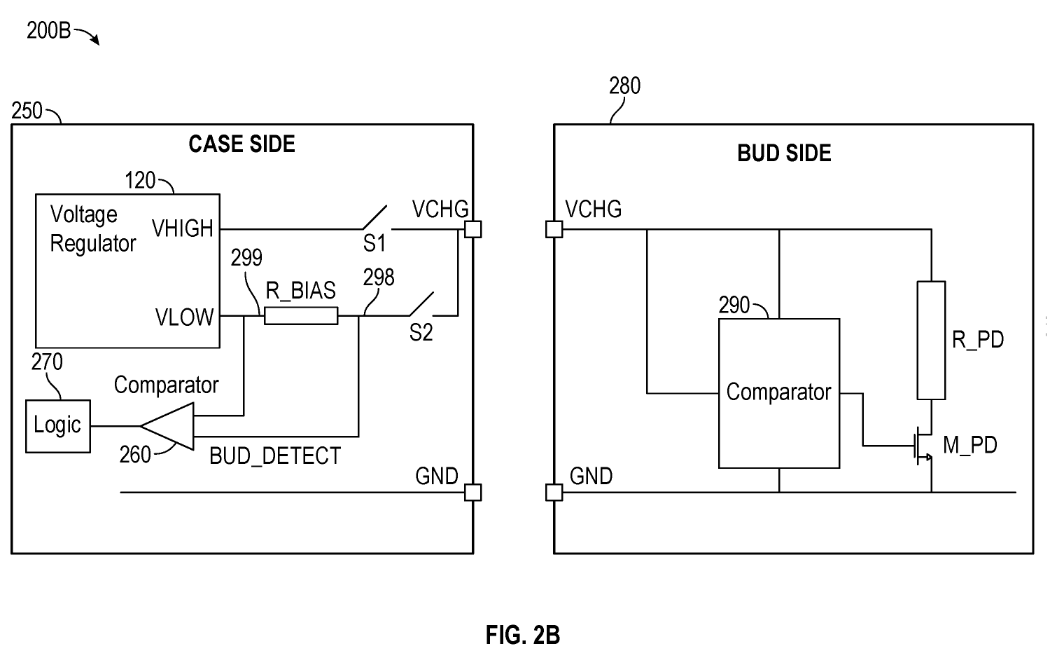

FIG. 2A is a block diagram of a three-connector device detection and charging system 200A that includes an example charging device circuit 210 (labeled “CASE SIDE”) and an example portable device circuit 240 (labeled “BUD SIDE”), in accordance with certain aspects of the present disclosure. The charging device circuit 210 is an example implementation of at least part of the charger 110 and may thus include the voltage regulator 120. The charging device circuit 210 may optionally include the battery 130 (not shown in FIG. 2A), which may be coupled to an input of the voltage regulator 120. The portable device circuit 240 is an example implementation of at least part of the portable device 140 and may thus include the battery 150 (not shown in FIG. 2A). The charging device circuit 210 may include a charging connector (labeled “VCHG”), a connection connector (labeled “CASE_CONNECT”), and a reference potential connector (labeled “GND”), for a total of three interface connectors. The portable device circuit 240 may include a corresponding VCHG connector, a corresponding CASE_CONNECT connector, and a corresponding GND connector, such that the portable device circuit 240 may be coupled (e.g., connected) to the charging device circuit 210 for charging the battery 150. As used herein, the term “connector” generally refers to an electrical connector, which may be implemented as a pin (or other male connector), a receptacle (or other female connector), a pad, or any other suitable means for electrical connection.

Referring to the charging device circuit 210, the VCHG connector may be coupled to a first output of the voltage regulator 120 (labeled “VHIGH”) for providing an output voltage for charging the battery (or batteries) 150 of the portable device circuit 240, when the charging device circuit 210 is connected to and configured to charge the battery 150 of the portable device circuit 240. In some aspects, the CASE_CONNECT connector may be coupled to a second output of the voltage regulator 120 (labeled “VLOW”) and a portable device detection node (e.g., an earbud detection node, labeled “BUD_DETECT”). The second output VLOW may be considered a voltage node configured to have a reference voltage that is lower than the VHIGH voltage. For other aspects, the reference voltage (e.g., a VLOW voltage) may be generated by another voltage regulator or any of other various suitable circuits. The charging device circuit 210 may include a resistive element (labeled “RBIAS”) coupled between the voltage node (e.g., the VLOW output) and the CASE_CONNECT connector. The GND connector of the charging device circuit 210 may be coupled to a reference potential node (e.g., electrical ground) of the charging device circuit 210.

Referring to the portable device circuit 240, the VCHG connector may be coupled to a first terminal of the battery (or batteries) 150 of the portable device circuit 240. The CASE_CONNECT connector may be coupled to an input of logic 245 (labeled “LOGIC”). The portable device circuit 240 may include a pulldown resistive element (labeled “R_PD”) coupled between the CASE_CONNECT connector and the GND connector. The logic 245 may receive power via a first power supply input (labeled “BUD BATTERY”) coupled to the battery (or batteries) 150 and second power supply input coupled to the GND connector. The logic 245 may also include a control output (labeled “CHIP_EN”). The GND connector of the portable device circuit 240 may also be coupled to a reference potential node (e.g., electrical ground) of the portable device circuit 240 and to a second terminal of the battery (or batteries) 150.

Referring again to the charging device circuit 210, when the portable device circuit 240 is coupled to the charging device circuit 210 (e.g., via the corresponding VCHG connectors, CASE_CONNECT connectors, and GND connectors), the BUD_DETECT node may toggle to a first signal level indicating that the portable device circuit 240 is detected (e.g., as a result of the resistive element R_PD providing a current path from the CASE_CONNECT connectors to the GND connectors such that a voltage drop is created across the RBIAS resistive element), and the voltage regulator 120 may be enabled to facilitate the charging of the battery associated with the portable device circuit 240. When the portable device circuit 240 is decoupled from the charging device circuit 210 (e.g., decoupling the connections between the charging device circuit 210 and the portable device circuit 240 through the VCHG connectors, the CASE_CONNECT connectors, and the GND connectors), the resistive element R_PD may be decoupled from the charging device circuit 210, the BUD_DETECT node may toggle to a second signal level indicating that the portable device circuit 240 is not detected, and the voltage regulator 120 may be disabled.

Referring again to the portable device circuit 240, the logic 245 may be configured to determine whether the charging device circuit 210 is coupled to the portable device circuit 240 based on a voltage at the CASE_CONNECT connector. For example, when the portable device circuit 240 is decoupled from the charging device circuit 210, the voltage at the CASE_CONNECT connector may effectively be zero (or close to zero) due to the R_PD resistive element tied to the reference potential node, whereas when the portable device circuit 240 is coupled to the charging device circuit 210, the voltage at the CASE_CONNECT connector may be greater than zero. However, when the battery 150 of the portable device circuit 240 is discharged (e.g., the battery 150 is dead, or at least significantly drained), the logic 245 may be unpowered, and may thus be unable to determine whether the portable device circuit 240 is coupled to the charging device circuit 210.

In certain aspects, and as described above, device detection between a portable device and a charging device may utilize three connectors on a portable device and three connectors on a charging device. In other aspects, device detection may include and utilize a sensor (e.g., a Hall Effect sensor) to detect the presence of the portable device. However, device detection utilizing three connectors on both the portable device and the charging device or a sensor may be costly and/or occupy substantial chip area on both the portable device and the charging device. Furthermore, and as illustrated above, the portable device may be unable to utilize device detection (e.g., to detect the presence of the charging circuit) when the battery of the portable device is discharged.

### Example Two-Connector Device Detection and Charging System

Certain aspects of the present disclosure provide techniques and apparatus for charging a portable device with a charging device using only two connectors between the devices. The portable device may include a charging connector and a reference potential connector, which correspond to a charging connector and a reference potential connector of the charging device. The portable device may also include (i) a pulldown resistive element and a pulldown transistor, coupled in series between the charging connector and the reference potential connector, and (ii) a comparator with an input coupled to the charging connector and an output coupled to a gate of the pulldown transistor. The comparator may be configured to control the pulldown transistor based on the voltage at the charging connector of the portable device.

For example, the comparator may turn on the pulldown transistor when a voltage at the charging connector is higher than a first voltage threshold, and disable (e.g., turn off) the pulldown transistor when the voltage at the charging connector is higher than a second voltage threshold. In this manner, the cost of implementing the device detection may be reduced, and chip area on the portable device (and/or the charging device) may be saved. In addition, the device detection described herein may function even when the battery of the portable device is discharged. Furthermore, the device detection described herein may also be performed without the use of a Hall Effect sensor.

FIG. 2B is a block diagram of a two-connector device detection and charging system 200B that includes an example charging device circuit 250 (labeled “CASE SIDE”) and an example portable device circuit 280 (labeled “BUD SIDE”) with two-connector device detection and charging, in accordance with certain aspects of the present disclosure. The charging device circuit 250 is an example implementation of at least part of the charger 110 and may thus include the voltage regulator 120 and optionally include the battery 130 (not shown in FIG. 2B). The portable device circuit 280 is an example implementation of at least part of the portable device 140 and may thus include the battery 150 (not shown in FIG. 2B). Accordingly, the portable device circuit 280 may be part of a power supply circuit and may be included in a portable speaker (e.g., a portable Bluetooth speaker) or a wearable device, such as a headphone (e.g., an over-ear headphone, on-ear headphone, or an in-ear headphone (such as an earbud), earphone, earpiece, ring, band (e.g., headband, neckband, armband, banded headset), hearing aid, or extended reality (XR) device (e.g., an augmented reality (AR), virtual reality (VR), or mixed reality (MR) device).

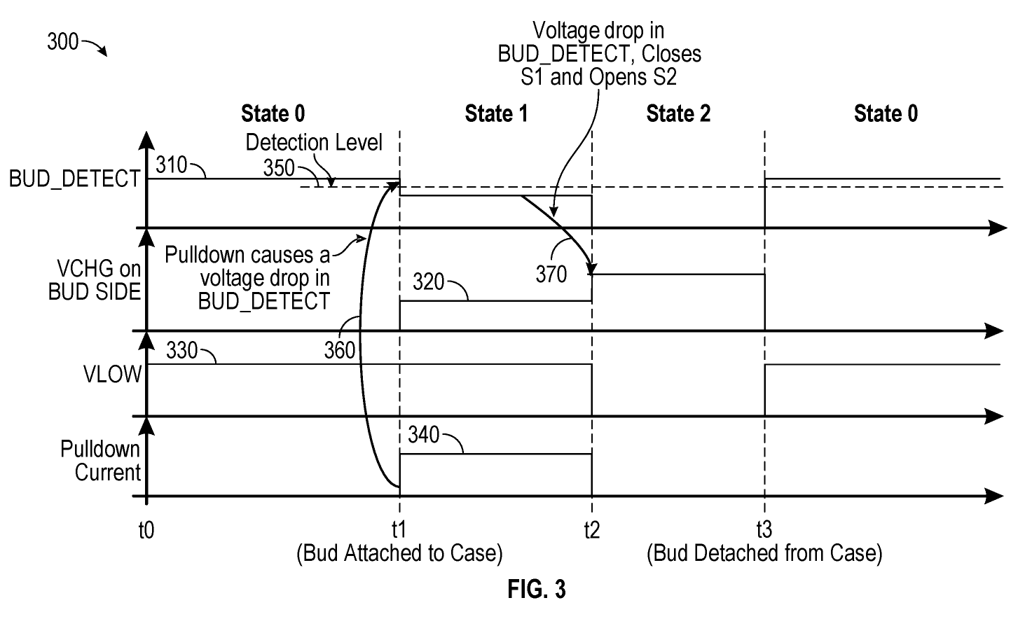

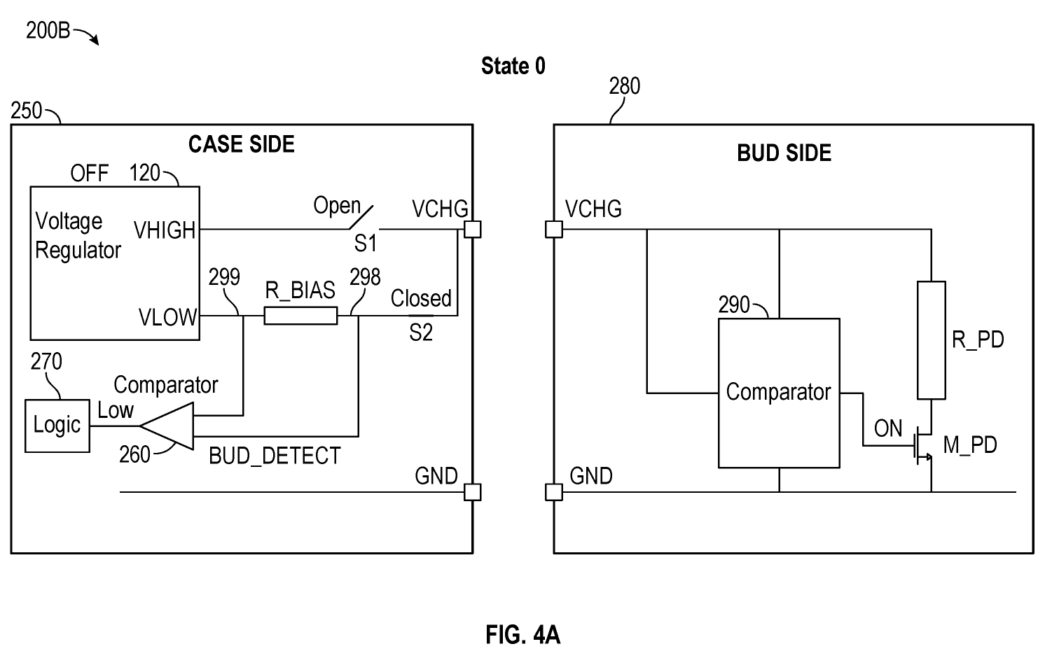

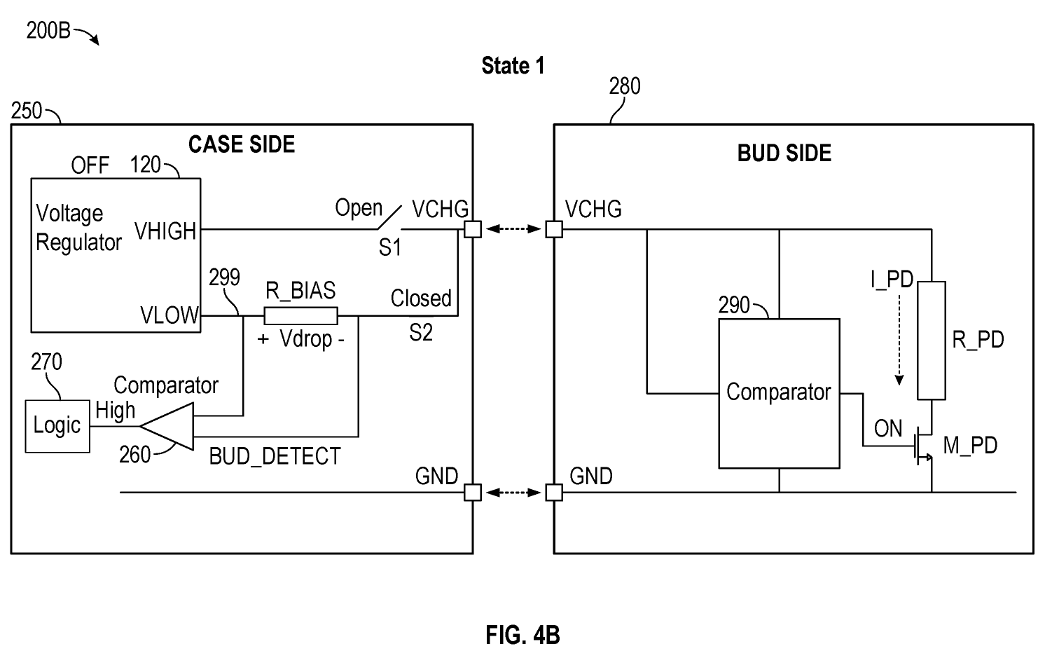

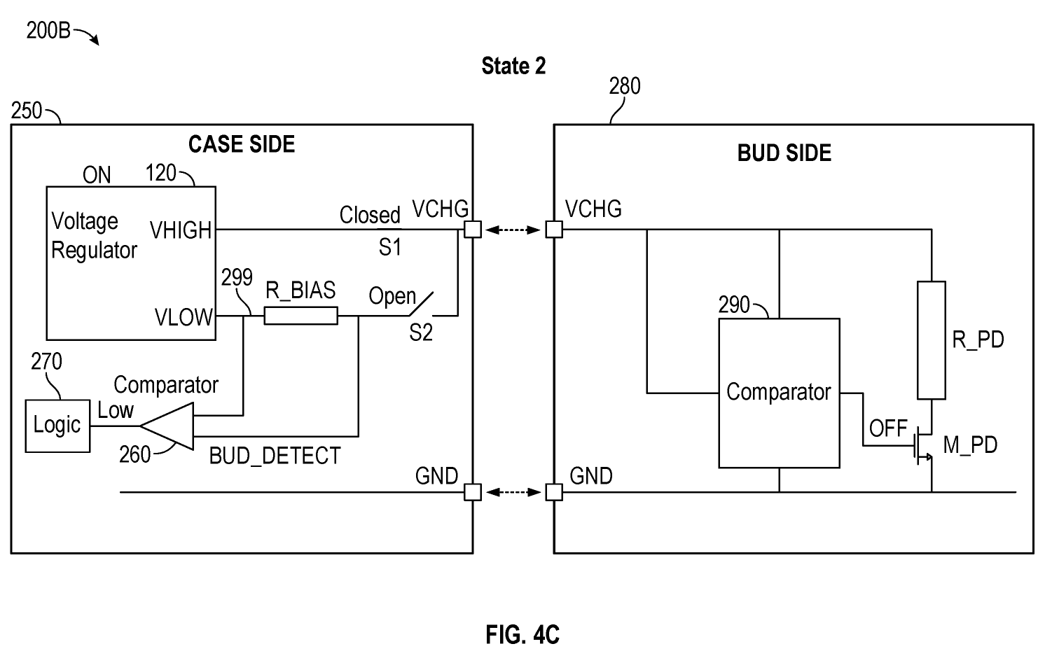

FIG. 3 is a timing diagram 300 illustrating voltage or current signals at one or more nodes or connectors of the example charging device circuit 250 and the example portable device circuit 280 of FIG. 2B during various states (e.g., State 0, State 1, and State 2), in accordance with certain aspects of the present disclosure. FIGS. 4A, 4B, and 4C are block diagrams of the two-connector device detection system 200B of FIG. 2B during State 0, State 1, and State 2, in accordance with certain aspects of the present disclosure. Due to their relationship, FIGS. 2B, 3, anf 4A-4C are herein described together for clarity.

The charging device circuit 250 may include a charging connector (e.g., a positive connector, labeled “VCHG”) and a reference potential connector (e.g., a negative connector, labeled “GND”). The VCHG connector and the GND connector of the charging device circuit 250 may be the only interface connectors of the charging device circuit 250 for coupling to the portable device circuit 280. In some cases, the VCHG connector and the GND connector of the charging device circuit 250 may include pogo pins or be configured to interface with pogo pins of the portable device circuit 280. The portable device circuit 280 may include a corresponding VCHG connector (with an associated voltage signal 320 shown in FIG. 3) and a corresponding GND connector. The VCHG connector and the GND connector of the portable device circuit 280 may be the only interface connectors of the portable device. In some cases, the VCHG connector and the GND connector of the portable device circuit 280 may include pogo pins or be configured to interface with pogo pins of the charging device circuit 250.

Referring to the charging device circuit 250, the VCHG connector may be selectively coupled to a first output of the voltage regulator 120 (labeled “VHIGH”) via a switch S1. The voltage regulator 120 may provide a regulated output voltage (e.g., a VHIGH voltage) for charging the battery (or batteries) 150 of the portable device circuit 280. The VCHG connector may also be selectively coupled to a node 298 (labeled “BUD_DETECT,” with an associated voltage signal 310 shown in FIG. 3) and a first input of a comparator 260 via a switch S2. The voltage signal 310 at the BUD_DETECT node 298 is illustrated in conjunction with a detection level 350 in FIG. 3. When the voltage of signal 310 is greater than the detection level 350, the portable device circuit 280 is not detected by the charging device, whereas when the voltage of signal 310 is less than the detection level 350, the portable device circuit 280 is detected by the charging device. A second input of the comparator 260 may be coupled to a second output of the voltage regulator 120 (labeled “VLOW,” with an associated voltage signal 330 shown in FIG. 3). The second output VLOW may be considered a voltage node 299 configured to have a reference voltage that is lower than the VHIGH voltage. For other aspects, the reference voltage (e.g., the VLOW voltage) may be generated by another voltage regulator or any of other various suitable circuits. The output of the comparator 260 may be coupled to logic 270. The logic 270 may be used to control the switches S1 and S2 and the voltage regulator 120 and may have control outputs (not shown) coupled to control inputs of the switches S1 and S2 and the voltage regulator 120. A resistive element (labeled “R_BIAS”) may be coupled between the voltage node 299 (e.g., the VLOW output) and the BUD_DETECT node 298, and the second input of the comparator 260 may be coupled to the node 298 between switch S2 and resistive element R_BIAS. The GND connector of the charging device circuit 250 may be coupled to a reference potential node (e.g., electrical ground) of the charging device circuit 250.

The portable device circuit 280 may include a resistive element (e.g., a pulldown resistive element, labeled “R_PD”), a transistor (e.g., a pulldown transistor, labeled “M_PD”), and a comparator 290. The transistor M_PD may be implemented as an n-type metal-oxide-semiconductor (NMOS) transistor, as illustrated. The resistive element R_PD may be coupled between the VCHG connector and a drain of the transistor M_PD, and a source of the transistor M_PD may be coupled to the GND connector. The VCHG connector may be coupled to a first terminal of the battery (or batteries) 150 of the portable device circuit 240.

In some cases, the comparator 290 may be a self-referenced comparator. The comparator 290 may include an input coupled to the VCHG connector and an output coupled to a gate of the transistor M_PD. The comparator 290 may have a first power supply input coupled to the VCHG connector and a second power supply input coupled to the GND connector. The GND connector of the portable device circuit 280 may be coupled to a reference potential node (e.g., electrical ground) of the portable device circuit 280 and a second terminal of the battery (or batteries) 150.

Starting from time t0 in FIG. 3, when the charging device circuit 250 is decoupled from the portable device circuit 280 (e.g., when the charging device circuit 250 and portable device circuit 280 are operating in State 0, illustrated in FIGS. 3 and 4A), the voltage of signal 320 at the VCHG connector may be lower than or equal to a first voltage threshold (e.g., 0V), and as a result, the comparator 290 may enable (e.g., turn on) the pulldown transistor M_PD (e.g., by default). In some cases, the pulldown transistor M_PD may be turned on by the comparator 290 in State 0 even when the battery 150 is significantly drained, using any remaining charge on a node coupled to the VCHG connector of the portable device circuit 280. In addition, in the charging device circuit 250, the voltage regulator 120 may be disabled (e.g., off), switch S1 may be open, switch S2 may be closed, and the bias voltage may be provided at the VLOW output (as shown by the voltage signal 330), as illustrated in FIG. 4A. As a result, there is no voltage drop across the resistive element R_BIAS, the voltage of the signal 330 at the VLOW output and the voltage of the signal 310 at the BUD_DETECT node 298 may be equal, and an output of the comparator 260 may be a logic low signal (e.g., logical “0”).

When the portable device circuit 280 is coupled (e.g., connected) to the charging device circuit 250 (e.g., when the charging device circuit 250 and portable device circuit 280 switch to operating in State 1, illustrated in FIGS. 3 and 4B, which is triggered at time t1), a voltage divider is created by the resistive elements R_BIAS and R_PD, and a pulldown current I_PD begins to flow through the resistive element R_PD (as illustrated by pulldown current signal 340 in FIG. 3). Thus, the voltage of signal 320 at the VCHG connector (a first voltage level) may be a proportion of the bias voltage and may be higher than the first voltage threshold but lower than a second voltage threshold (e.g., a reference voltage of the comparator 290). With this mid-level voltage of signal 320, the comparator 290 may keep the pulldown transistor M_PD turned on, as illustrated in FIG. 4B. As a result of the flowing pulldown current I_PD (as depicted by arrow 360), a voltage drop (labeled “Vdrop”) may occur across the resistive element R_BIAS in the charging device circuit 250, such that the voltage of signal 310 at the BUD_DETECT node is lower than the voltage of signal 330 at the voltage node 299 (e.g., the VLOW output). When the voltage of signal 310 at the BUD_DETECT node drops below the detection level 350, the charging device circuit 250 may determine that the portable device is coupled to the charging device in State 1. Due to this voltage drop at the BUD_DETECT node, the output of the comparator 260 may change to a logic high signal (e.g., logical “1”) in State 1.

In response to the comparator output transitioning from logic low to logic high, switch S1 may transition from being open to being closed, switch S2 may transition from being closed to being open, and the voltage regulator 120 may be enabled (e.g., turned on) at time t2, which provides the regulator output voltage to the VCHG connector, thereby increasing the voltage of signal 320 at the VCHG connector to a second voltage level. In some cases, the voltage regulator 120 may be enabled (following the establishment of the voltage drop across the resistive element R_BIAS and the comparator outputting a logic high signal) after a delay. As shown in FIG. 3, the charging device circuit 250 and the portable device circuit 280 may transition from operating in State 1 to operating in State 2 at time t2 in response to the voltage drop across the resistive element R_BIAS (as indicated by arrow 370). In State 2 as illustrated in FIG. 4C, the charging device may charge the battery 150 of the portable device using power from the voltage regulator 120.

When the voltage regulator 120 is enabled in the charging device circuit 250 (e.g., when the charging device circuit 250 and portable device circuit 280 are operating in State 2, illustrated in FIGS. 3 and 4C), the comparator 290 may turn off the transistor M_PD to prevent (or at least reduce) the wasting of current from the charging device circuit 250, as illustrated in FIG. 4C. As a result of switch S2 being opened, no current may flow across the resistive element R_BIAS, the voltage of the BUD_DETECT node may equal the voltage at the voltage node 299 (e.g., the VLOW voltage), and the output of the comparator 260 may change to a logic low signal (e.g., logical “0”). In some cases, the reference voltage in the charging device circuit 250 may cease to be provided at the voltage node 299 (e.g., the VLOW output) in State 2, as illustrated by the voltage signal 330.

The charging device circuit 250 and the portable device circuit 280 may transition from operating in State 2 to operating in State 0 (e.g., which is triggered at time t3) when the portable device circuit 280 is decoupled from the charging device circuit 250. When operating in State 2, the charging device circuit 250 may transition to operating in State 0 when the charging device circuit 250 determines that no current is drawn from the voltage regulator 120 (e.g., by the portable device circuit 280). In some cases, the charging device circuit 250 may determine that no current is drawn from the voltage regulator 120 (and thus that the portable device circuit 280 has been disconnected from the charging device circuit 250) based on the output of the comparator 260 changing to a logic low signal. The portable device circuit 280 may transition from operating in State 2 to operating in State 0 and turning on transistor M_PD when the voltage signal 320 at the VCHG connector falls below the second voltage threshold.

### Example Charging Operations

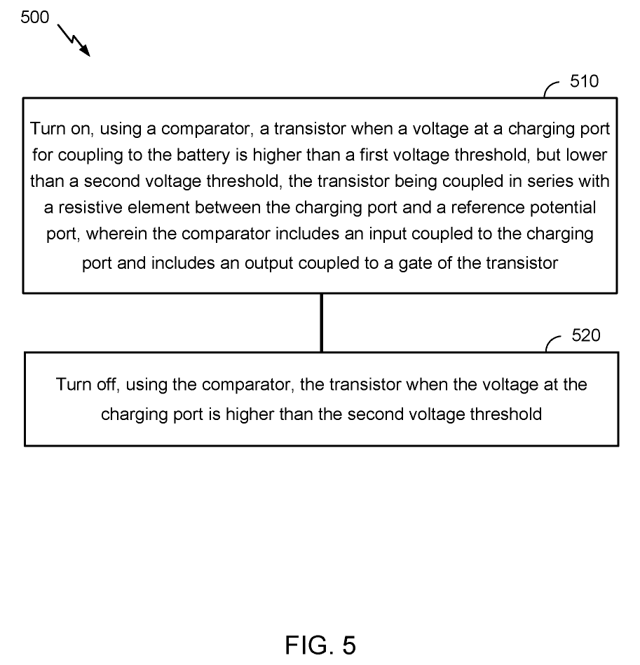

FIG. 5 is a flow diagram of example operations 500 for charging a portable device (e.g., the portable device 140 of FIG. 1 or a portable device with the portable device circuit 280 of FIGS. 2B and 4A-4C) with a battery (e.g., battery (or batteries) 150), in accordance with certain aspects of the present disclosure. In certain aspects, the portable device may include one of a headphone, an earbud, a speaker, or an extended reality (XR) device.

The operations 500 may include, at block 510, turning on, using a comparator (e.g., comparator 290), a transistor (e.g., transistor M_PD) when a voltage at a charging connector (e.g., the VCHG connector of the portable device) for coupling to the battery is higher than a first voltage threshold (e.g., 0V), but lower than a second voltage threshold (e.g., a reference voltage of the comparator 290). The transistor may be coupled in series with a resistive element (e.g., pulldown resistive element R_PD) between the charging connector and a reference potential connector (e.g., the GND connector of the portable device). The comparator may include an input coupled to the charging connector and include an output coupled to a gate of the transistor.

In certain aspects, the charging connector and the reference potential connector may be the only interface connectors of the portable device. The transistor may include an n-type metal-oxide-semiconductor (NMOS) transistor, a drain of the NMOS transistor may be coupled to the resistive element, and a source of the NMOS transistor may be coupled to the reference potential connector. In some cases, the comparator may be a self-referenced comparator. In certain aspects, the charging connector and the reference potential connector may include pogo pins or be configured to interface with pogo pins of a charger.

At block 520, the operations 500 may include turning off, using the comparator, the transistor when the voltage at the charging connector is higher than the second voltage threshold.

According to certain aspects, the operations 500 may further include powering the comparator via the charging connector.

According to certain aspects, the operations 500 may further include, after turning off the transistor, turning on the transistor, using the comparator, when the voltage at the charging connector falls below the second voltage threshold.

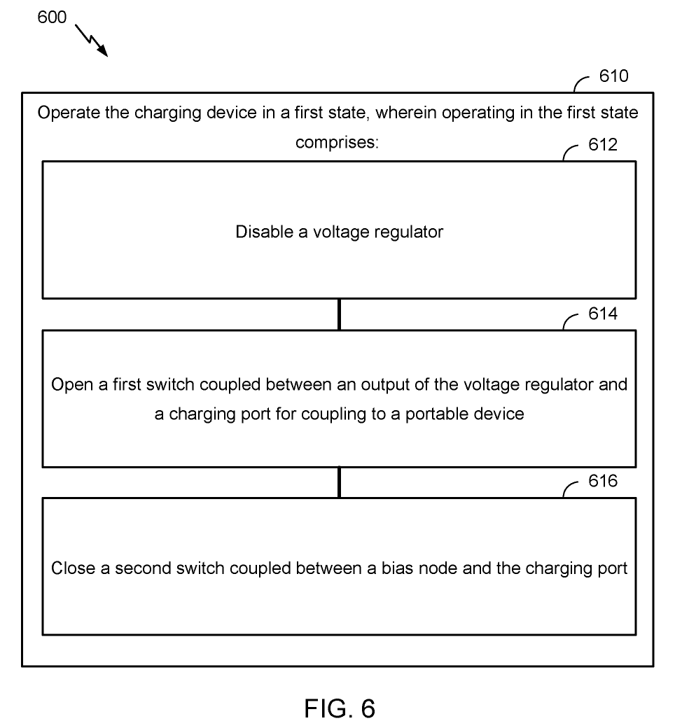

FIG. 6 is a flow diagram of example operations 600 for using a charging device (e.g., charger 110 of FIG. 1 or a charging device with the charging device circuit 250 of FIGS. 2B and 4A-4C) to supply power, in accordance with certain aspects of the present disclosure.

The operations 600 may include, at block 610, operating the charging device in a first state (e.g., State 0). Operating the charging device in the first state may include (i) disabling a voltage regulator (e.g., voltage regulator 120) at block 612, (ii) opening a first switch (e.g., switch S1) coupled between an output of the voltage regulator and a charging connector (e.g., the VCHG connector of the charging device) for coupling to a portable device (e.g., a portable device with the portable device circuit 280) at block 614, and (iii) closing a second switch (e.g., switch S2) coupled between a voltage node (e.g., voltage node 299, such as the VLOW output) and the charging connector at block 616.

In certain aspects, (i) operating in the first state at block 610 may further include outputting a logic low signal (e.g., logical “0”) from a comparator (e.g., comparator 260), (ii) the comparator may include a first input coupled to the voltage node and a second input coupled to a node between the second switch and a resistive element (e.g., resistive element R_BIAS), (iii) the resistive element may be coupled between the voltage node and the second switch, and (iv) operating in the first state at block 610 may be based on no voltage drop across the resistive element being determined by the comparator, as indicated by the logic low signal.

According to certain aspects, the operations 600 may further include operating the charging device in a second state (e.g., State 1) after operating the charging device in the first state at block 610, based on determining a voltage drop across the resistive element using the comparator. Operating in the second state may include outputting a logic high signal (e.g., logical “1”) from the comparator while the first switch is closed and the second switch is open.

According to certain aspects, the operations 600 may further include operating the charging device in a third state (e.g., State 2) after operating the charging device in the second state. Operating in the third state may include (i) closing the first switch, (ii) opening the second switch, (iii) enabling the voltage regulator, (iv) supplying current to the charging connector from the voltage regulator, and (v) outputting the logic low signal from the comparator.

According to certain aspects, the operations 600 may further include operating the charging device in the first state after operating the charging device in the third state, based on determining no current draw from the voltage regulator.

In certain aspects, the charging device may include a reference potential connector (e.g., the GND connector of the charging device) for coupling to the portable device. The charging connector and the reference potential connector may be the only interface connectors for coupling to the portable device.

### Example Aspects

In addition to the various aspects described above, specific combinations of aspects are within the scope of the disclosure, some of which are detailed below:

Aspect 1: A portable device configured to receive power from a battery, the portable device comprising: a charging connector for coupling to the battery; a reference potential connector; a resistive element and a transistor coupled in series between the charging connector and the reference potential connector; and a comparator including an input coupled to the charging connector and an output coupled to a gate of the transistor.

Aspect 2: The portable device of Aspect 1, wherein the charging connector and the reference potential connector are the only interface connectors of the portable device, wherein the charging connector is for coupling to a first terminal of the battery, and wherein the reference potential connector is for coupling to a second terminal of the battery.

Aspect 3: The portable device of Aspect 1 or 2, wherein the comparator is a self-referenced comparator.

Aspect 4: The portable device according to any of Aspects 1–3, wherein the comparator is configured to turn on the transistor when a voltage at the charging connector is higher than a first voltage threshold, but lower than a second voltage threshold.

Aspect 5: The portable device of Aspect 4, wherein the comparator is further configured to turn off the transistor when the voltage at the charging connector is higher than the second voltage threshold.

Aspect 6: The portable device of Aspect 1, wherein the comparator is configured to turn on the transistor when a voltage at the charging connector is lower than or equal to a first voltage threshold.

Aspect 7: The portable device of Aspect 6, wherein the comparator is further configured to turn off the transistor when the voltage at the charging connector is higher than a second voltage threshold, the second voltage threshold being higher than the first voltage threshold.

Aspect 8: The portable device according to any of Aspects 1–7, wherein the transistor comprises an n-type metal-oxide-semiconductor (NMOS) transistor, wherein a drain of the NMOS transistor is coupled to the resistive element, and wherein a source of the NMOS transistor is coupled to the reference potential connector.

Aspect 9: The portable device according to any of Aspects 1–8, wherein the comparator includes a power supply input coupled to the charging connector.

Aspect 10: The portable device according to any of Aspects 1–9, wherein the portable device comprises one of a headphone, an earbud, a portable speaker, or an extended reality (XR) device.

Aspect 11: The portable device according to any of Aspects 1–10, wherein the charging connector and the reference potential connector comprise pogo pins or are configured to interface with pogo pins of a charger.

Aspect 12: A method of charging a portable device with a battery, comprising: turning on, using a comparator, a transistor when a voltage at a charging connector for coupling to the battery is higher than a first voltage threshold, but lower than a second voltage threshold, the transistor being coupled in series with a resistive element between the charging connector and a reference potential connector, wherein the comparator includes an input coupled to the charging connector and includes an output coupled to a gate of the transistor; and turning off, using the comparator, the transistor when the voltage at the charging connector is higher than the second voltage threshold.

Aspect 13: The method of Aspect 12, wherein the charging connector and the reference potential connector are the only interface connectors of the portable device.

Aspect 14: The method of Aspect 12 or 13, wherein the transistor comprises an n-type metal-oxide-semiconductor (NMOS) transistor, wherein a drain of the NMOS transistor is coupled to the resistive element, and wherein a source of the NMOS transistor is coupled to the reference potential connector.

Aspect 15: The method according to any of Aspects 12–14, wherein the comparator is a self-referenced comparator.

Aspect 16: The method according to any of Aspects 12–15, further comprising powering the comparator via the charging connector.

Aspect 17: The method according to any of Aspects 12–16, further comprising, after turning off the transistor, turning on the transistor, using the comparator, when the voltage at the charging connector falls below the second voltage threshold.

Aspect 18: The method according to any of Aspects 12–17, wherein the portable device comprises one of a headphone, an earbud, a speaker, or an extended reality (XR) device.

Aspect 19: The method according to any of Aspects 12–18, wherein the charging connector and the reference potential connector comprise pogo pins or are configured to interface with pogo pins of a charger.

Aspect 20: A charging device configured to supply power to a portable device, the charging device comprising: a charging connector for coupling to the portable device; a voltage regulator; and selection circuitry coupled between the voltage regulator and the charging connector, the selection circuitry being configured to selectively apply a voltage to the charging connector.

Aspect 21: The charging device of Aspect 20, further comprising a reference potential connector for coupling to the portable device, wherein the charging connector and the reference potential connector are the only interface connectors for coupling to the portable device.

Aspect 22: The charging device of Aspect 20 or 21, wherein the selection circuity comprises: a first switch coupled between an output of the voltage regulator and the charging connector; a voltage node; and a second switch coupled between the charging connector and the voltage node.

Aspect 23: The charging device of Aspect 22, further comprising: a resistive element coupled between the voltage node and the second switch; and a comparator including a first input coupled to the voltage node and a second input coupled to a node between the second switch and the resistive element.

Aspect 24: The charging device of Aspect 23, wherein when the charging device is operating in a first state: the voltage regulator is configured to be disabled; the first switch is configured to be open; the second switch is configured to be closed; and the comparator is configured to output a logic low signal.

Aspect 25: The charging device of Aspect 24, wherein when the charging device is operating in a second state: the voltage regulator is configured to be disabled; the first switch is configured to be open; the second switch is configured to be closed; and the comparator is configured to output a logic high signal.

Aspect 26: The charging device of Aspect 25, wherein the charging device is configured to transition from operating in the first state to operating in the second state in response to a voltage drop across the resistive element.

Aspect 27: The charging device of Aspect 25 or 26, wherein when the charging device is operating in a third state: the voltage regulator is configured to be enabled; the comparator is configured to output a logic low signal; the first switch is configured to be closed; and the second switch is configured to be open.

Aspect 28: The charging device according to any of Aspects 20–27, wherein the voltage regulator comprises a boost converter.

Aspect 29: The charging device according to any of Aspects 20–28, further comprising a reference potential connector for coupling to the portable device, wherein the charging connector and the reference potential connector comprise pogo pins or are configured to interface with pogo pins of the portable device.

Aspect 30: A portable charging case comprising the charging device according to any of Aspects 20–29, the portable charging case further comprising a battery coupled to an input of the voltage regulator.

Aspect 31: A method of using a charging device to supply power, comprising: operating the charging device in a first state, wherein operating in the first state comprises: disabling a voltage regulator; opening a first switch coupled between an output of the voltage regulator and a charging connector for coupling to a portable device; and closing a second switch coupled between a voltage node and the charging connector.

Aspect 32: The method of Aspect 31, wherein: operating in the first state further comprises outputting a logic low signal from a comparator; the comparator includes a first input coupled to the voltage node and a second input coupled to a node between the second switch and a resistive element; the resistive element is coupled between the voltage node and the second switch; and operating in the first state is based on no voltage drop across the resistive element being determined by the comparator, as indicated by the logic low signal.

Aspect 33: The method of Aspect 32, further comprising operating the charging device in a second state after operating the charging device in the first state, based on determining a voltage drop across the resistive element using the comparator, wherein operating in the second state comprises outputting a logic high signal from the comparator while the first switch is closed and the second switch is open.

Aspect 34: The method of Aspect 33, further comprising operating the charging device in a third state after operating the charging device in the second state, wherein operating in the third state comprises: closing the first switch; opening the second switch; enabling the voltage regulator; supplying current to the charging connector from the voltage regulator; and outputting the logic low signal from the comparator.

Aspect 35: The method of Aspect 34, further comprising operating the charging device in the first state after operating the charging device in the third state, based on determining no current draw from the voltage regulator.

Aspect 36: The method according to any of Aspects 31–35, wherein the charging device comprises a reference potential connector for coupling to the portable device and wherein the charging connector and the reference potential connector are the only interface connectors for coupling to the portable device.

Aspect: 37: A method of using a charging device to supply power, the method comprising: operating the charging device in a first state, wherein operating in the first state comprises: (i) disabling a first voltage output of a voltage regulator; (ii) opening a first switch coupled between the high voltage output of the voltage regulator and a charging connector for coupling to a portable device; and (iii) closing a second switch coupled between a second voltage output of the voltage regulator and the charging connector.

Aspect 39: The method of Aspect 38, further comprising operating the charging device in a second state after operating the charging device in the first state, based on determining a voltage drop across the resistive element using the comparator, wherein operating in the second state comprises outputting a logic high signal from the comparator while the first switch is closed and the second switch is open.

Aspect 40: The method of Aspect 39, further comprising operating the charging device in a third state after operating the charging device in the second state, wherein operating in the third state comprises: closing the first switch; opening the second switch; enabling the first voltage output of the voltage regulator; supplying current to the charging connector from the voltage regulator; and outputting the logic low signal from the comparator.

Aspect 41: The method of Aspect 40, further comprising operating the charging device in the first state after operating the charging device in the third state, based on determining no current draw from the voltage regulator.

Aspect 42: The method according to any of Aspects 37–41, wherein the charging device comprises a reference potential connector for coupling to the portable device and wherein the charging connector and the reference potential connector are the only interface connectors for coupling to the portable device.

### ADDITIONAL CONSIDERATIONS

The various operations of methods described above may be performed by any suitable means capable of performing the corresponding functions. The means may include various hardware and/or software component(s) and/or module(s), including, but not limited to a circuit, an application-specific integrated circuit (ASIC), or processor. Generally, where there are operations illustrated in figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A portable device configured to receive power from a battery, the portable device comprising:
a charging connector for coupling to the battery;
a reference potential connector;
a resistive element and a transistor coupled in series between the charging connector and the reference potential connector; and
a comparator including an input coupled to the charging connector and an output coupled to a gate of the transistor.

2. The portable device of claim 1, wherein the charging connector and the reference potential connector are the only interface connectors of the portable device, wherein the charging connector is for coupling to a first terminal of the battery, and wherein the reference potential connector is for coupling to a second terminal of the battery.

3. The portable device of claim 1, wherein the comparator is a self-referenced comparator.

4. The portable device of claim 1, wherein the comparator is configured to turn on the transistor when a voltage at the charging connector is higher than a first voltage threshold, but lower than a second voltage threshold.

5. The portable device of claim 4, wherein the comparator is further configured to turn off the transistor when the voltage at the charging connector is higher than the second voltage threshold.

6. The portable device of claim 1, wherein the comparator is configured to turn on the transistor when a voltage at the charging connector is lower than or equal to a first voltage threshold.

7. The portable device of claim 6, wherein the comparator is further configured to turn off the transistor when the voltage at the charging connector is higher than a second voltage threshold, the second voltage threshold being higher than the first voltage threshold.

8. The portable device of claim 1, wherein the transistor comprises an n-type metal-oxide-semiconductor (NMOS) transistor, wherein a drain of the NMOS transistor is coupled to the resistive element, and wherein a source of the NMOS transistor is coupled to the reference potential connector.

9. The portable device of claim 1, wherein the comparator includes a power supply input coupled to the charging connector.

10. The portable device of claim 1, wherein the portable device comprises one of a headphone, an earbud, a portable speaker, or an extended reality (XR) device.

11. The portable device of claim 1, wherein the charging connector and the reference potential connector comprise pogo pins or are configured to interface with pogo pins of a charger.

12. A method of charging a portable device with a battery, comprising:
turning on, using a comparator, a transistor when a voltage at a charging connector for coupling to the battery is higher than a first voltage threshold, but lower than a second voltage threshold, the transistor being coupled in series with a resistive element between the charging connector and a reference potential connector, wherein the comparator includes an input coupled to the charging connector and includes an output coupled to a gate of the transistor; and
turning off, using the comparator, the transistor when the voltage at the charging connector is higher than the second voltage threshold.

13. The method of claim 12, wherein the charging connector and the reference potential connector are the only interface connectors of the portable device.

14. The method of claim 12, wherein the transistor comprises an n-type metal-oxide-semiconductor (NMOS) transistor, wherein a drain of the NMOS transistor is coupled to the resistive element, and wherein a source of the NMOS transistor is coupled to the reference potential connector.

15. The method of claim 12, wherein the comparator is a self-referenced comparator.

16. The method of claim 12, further comprising powering the comparator via the charging connector.

17. The method of claim 12, further comprising, after turning off the transistor, turning on the transistor, using the comparator, when the voltage at the charging connector falls below the second voltage threshold.

18. The method of claim 12, wherein the portable device comprises one of a headphone, an earbud, a speaker, or an extended reality (XR) device.

19. The method of claim 12, wherein the charging connector and the reference potential connector comprise pogo pins or are configured to interface with pogo pins of a charger.

20. The method of claim 12, wherein the turning on the transistor comprises turning on the transistor when the battery is completely drained.
